(19) United States
(12) Patent Application Publication
(10) Pub. No.: US 2026/0211689 A1
(43) Pub. Date: Jul. 23, 2026

(54) UNIFYING BIOS/APPLICATION COMMUNICATION THROUGH UEFI HUMAN INTERFACE INFRASTRUCTURE OVER WINDOWS MANAGEMENT INSTRUMENTATION

(71) Applicant: DELL PRODUCTS L.P., Round Rock, TX (US)

(72) Inventors: Che-Chang Lu, New Taipei City (TW); Chan-Wei Chen, Wugu (TW)

(21) Appl. No.: 19/033,027

(22) Filed: Jan. 21, 2025

(51) Int. Cl. G06F 9/4401

(52) U.S. Cl. CPC G06F 9/4411; G06F 9/4406

(57) ABSTRACT

An information handling system includes a Unified Extensible Firmware Interface (UEFI) and an operating system (OS). The UEFI includes a human interface infrastructure (HII). The OS includes a Windows management instrumentation (WMI). The application is configured to invoke the WMI to query the HII, to receive information related to a function of the UEFI from the HII via the WMI, and to incorporate the function into the application.

### FIELD OF THE DISCLOSURE

This disclosure relates to information handling systems, and more particularly relates to unifying BIOS/application communication through UEFI human interface infrastructure (HII) over Windows management instrumentation (WMI) in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a Unified Extensible Firmware Interface (UEFI) and an operating system (OS). The UEFI may be instantiated on a processor of the information handling system and includes a human interface infrastructure (HII). The OS may include a Windows management instrumentation (WMI). An application may be instantiated on the OS and may be configured to invoke the WMI to query the HII, to receive information related to a function of the UEFI from the HII via the WMI, and to incorporate the function into the application.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 illustrates an information handling system according to an embodiment of the present disclosure;

FIG. 2 illustrates a method for unifying BIOS/application communication through UEFI HII over WMI in an information handling system according to an embodiment of the present disclosure; and

FIG. 3 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

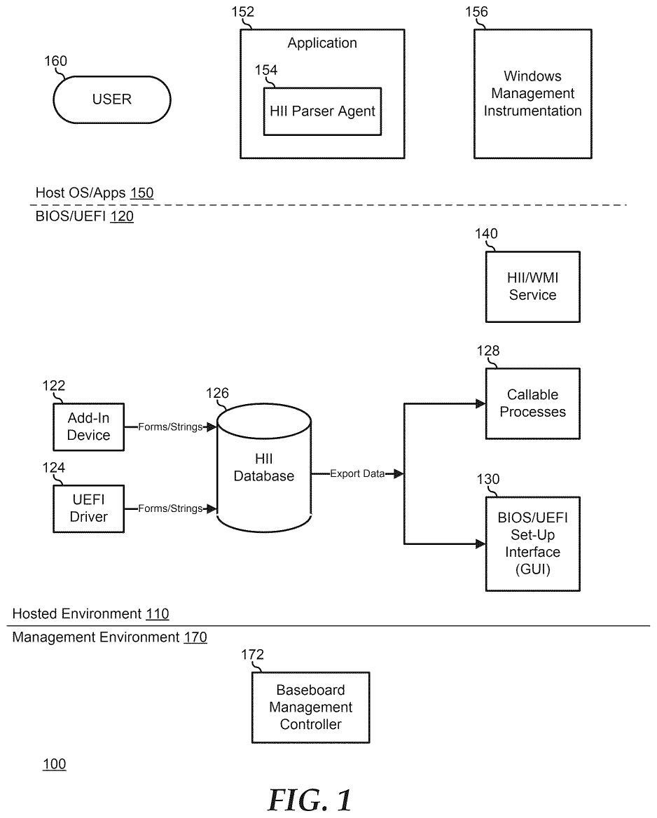

FIG. 1 illustrates an information handling system 100 including a hosted environment 110 and a management environment 120. Hosted environment 110 represents a processing environment established on information handling system 100 that is based on a processor (CPU) and the associated hardware devices, and that is commonly associated with the processing tasks that the information handling system performs at the behest of a user 160. Hosted environment 110 includes a basic input/output system (BIOS)/Universal Extensible Firmware Interface (UEFI) layer 120 (henceforth referred to as “BIOS/UEFI 120”), and a host operating system (OS) and application layer 150 (henceforth referred to as “host OS/apps 150”). BIOS/UEFI 120 represents a code operable to detect resources within information handling system 100, to provide drivers for the resources, initialize the resources, and access the resources. The functions and features of a BIOS/UEFI are known in the art and will not be further disclosed herein, except as may be needed to illustrate the current embodiments.

BIOS/UEFI 120 includes resources for an add-in device 122, a UEFI driver 124, a UEFI human interface infrastructure (HII) database 126 (henceforth referred to as “HII database”), a set of callable processes 128, a BIOS/UEFI set-up interface 130 (hence forth referred to as a “graphical user interface (GUI) 130”), and a HII/Windows management infrastructure (WMI) service 140 (henceforth referred to as HII/WMI service 140. Add-in device resources 122 and UEFI driver 124 represent functions and features provided on information handling system 100 that are based upon device hardware (for the add-in device resources), or firmware (for the UEFI driver). In particular, add-in device resources 122 and UEFI driver 124 provide settings, or knobs, that can be set to direct the ways in which the associated hardware or firmware operates in information handling system 100. More particularly, add-in device resources 122 and UEFI driver 124 may be associated with what is commonly referred to as “BIOS settings.”

BIOS/UEFI 120 includes functions and features that implement an interface infrastructure (that is, HII) that manages user inputs to permit developers (such as original equipment manufactures (OEMs) or independent BIOS developers (IBVs)) to design graphical interfaces for pre-boot configuration of information handling system 100. In particular HII provides a unified way to create and display user interfaces for BIOS settings, system configurations, boot options, or the like. Further HII provides mechanisms to manage these user interfaces, including how to gather user input, how to change system configurations, and how to display the results of the changes. In particular, HII permits a simplified and streamlined mechanism for creating an interactive interface that allows users to configure and manage BIOS settings. Typically a user accesses the user interface by pressing a specific key (such as F2, F10, or Delete) when the computer starts up. In the user interface, the user may adjust various hardware and boot options, such as modifying the boot order, enabling or disabling devices, enabling Secure Boot, changing CPU performance or communication interface setting, or the like. The functions and features of HII are known in the art and will not be further disclosed herein, except as may be needed to illustrate the current embodiments.

Within the context of the HII implemented on BIOS/UEFI 120, add-in device resources 122 and UEFI driver 124 each provide interface information related to the functions and features of the associated hardware or firmware to HII database 126. The interface information may include forms, strings, fonts, or the like that are stored in HII database 126, and form the basis for the creation of callable processes 128 and GUI 130. In particular, the interface information provides the mechanism whereby changes made by a user in GUI 130 are translated into callable processes 128 that feed back to effect the desired setting changes in add-in device resources 122 and UEFI driver 124. HII/WMI service 140 will be described further below.

Host OS/apps 150 represents user-level functions and features instantiated on information handling system 100 that provide the OS launched by BIOS/UEFI 120, and the applications, programs, utilities, or the like, that are instantiated on the OS to provide the functionality of the information handling system as desired by a user 160. The functions and features of an OS and the applications launched on an OS are known in the art and will not be further described herein, except as may be needed to illustrate the current embodiments. Host OS/apps 150 includes an application 152 with an embedded HII parser agent 154, and an instantiation of WMI 156.

WMI 156 represents a set of extensions in a Windows-based OS that provide an interface through which components of information handling system 100 provide information and notifications related to their operations, and through which a system administrator can monitor, manage, and maintain the operating state of the information handling system. In particular, WMI 156 provides a management interface to information handling system 100 that is present in hosted environment 120. That is, WMI 156 provides run time access to the management features and settings of the components of information handling system 100, in contrast to the HII features that are typically utilized at system power on or by developers to create GUI 130 prior to the deployment of the information handling system to the users.

In a particular embodiment, application 152 includes HII parser agent 154 that accesses the information from HII database 126 to effect changes to the BIOS settings, to become informed when new hardware or features are added or when existing hardware or features are deleted, or other underlying changes as may be provided by the HII database. In this way, application 152, by the inclusion of HII parser agent 154, becomes adaptable to the changing conditions of the hardware and feature set of information handling system 100, as needed or desired. Note that previously, such adaptability on the part of an application would be provided by making changes directly to the application, for example, during an application development process. In this embodiment, HII parser agent 154 works through WMI 156 to delve into BIOS/UEFI 120. In this regard, WMI 156 accesses the information from HII database 126 through HII/WMI service 140. In this way, when HII database 126 becomes aware of changes, for example, changes to add-in device resources 122 and UEFI driver 124, the HII database incorporates the changes into the HII database. For example, a driver for the add-in device may be updated to unlock new functionality of the add-in device, and such new functionality will be reflected in HII database 126.

In a particular case, HII parser agent 154 operates to periodically query WMI 156 to determine if the information in HII database 126 has changed, and the WMI requests the information from the HII database via HII/WMI service 140. If the information has changed, HII parser agent 154 operates to outline the changes to application 152 to incorporate the changes as needed or desired. For example, application 152 may be configured to automatically avail itself of particular changes and to ignore other changes. Here, application 152 may represent an office productivity program that utilizes print services routinely. In this case, application 152 may incorporate changes to the capabilities of an attached printer, while ignoring changes to the selected BIOS boot order.

In another case, HII parser agent 154 operates to be provided with an indication of HII database 126 information changes when they happen. That is, information handling system 100 may operate to push change information to HII parser agent 154 when the changes occur.

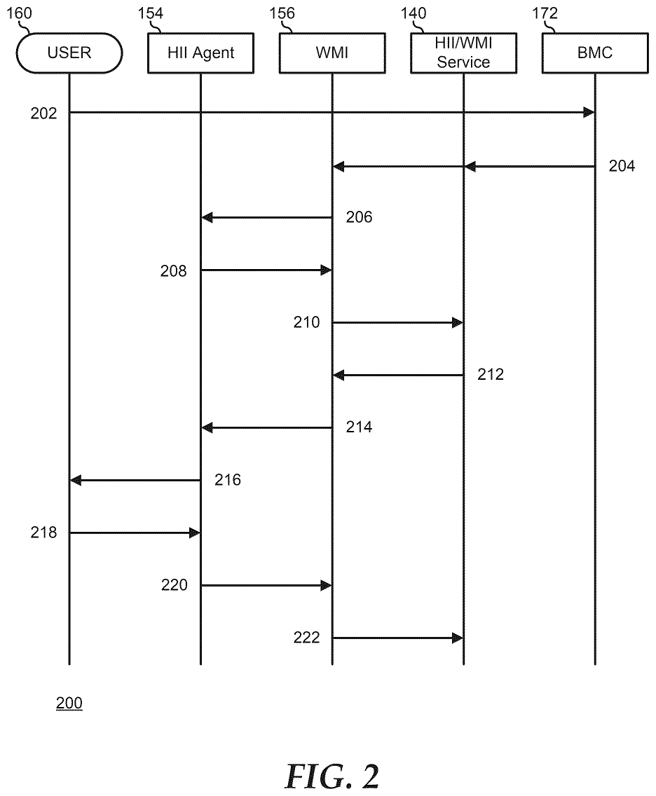

FIG. 2 illustrates a method 200 for unifying BIOS/application communication through UEFI HII over WMI in an information handling system. In a first step 202, user 160 takes an action to indicate that a new function of feature is to be incorporated to the information handling system. For example, user 160 may press a key on a keyboard, and the key press is detected by BMC 172. BMC 172 represents a processor that operates out-of-band from hosted environment 110 to monitor, manage, and maintain the functions and features of information handling system 100. As such, BMC 172 receives the indication via, for example, a Serial Communications Interface (SCI). In step 204, BMC 172 sends the indication to WMI 156 via HII/WMI service 140, and in step 206, the WMI forwards the indication to HII agent 154 in application 152. The indication from BMC 172 may represent a generic indication that the action was taken by user 160, or may include the indication that the action was taken and an index to HII database 126, as needed or desired.

HII agent 154 responds to the indication with a request back to WMI 156 to query HII database 126 in step 208, and the WMI sends the query to the HII database via HII/WMI service 140 in step 210. Pseudocode for the query may include:
oneof varid=CNV_VFR_CONFIG_SETUP_SampleFunction,
   prompt=STRING_TOKEN(STR_SAMPLE-FUNCTION-PROMPT-HELP),
   help=STRING_TOKEN(STR_SAMPLE_FUNCTION_PROMPT_HELP),
   option text=STRING_TOKEN(STR_ENABLED), value=1, flags=DEFAULT |RESET_REQUIRED;
   option text=STRING_TOKEN(STR_DISABLED), value=0, flags=RESET_REQUIRED;
endoneof;

HII/WMI service 140 queries HII database 126 and returns the forms from the HII database to WMI in step 212 and the WMI returns the forms to HII agent 154 in step 214. Application 152 displays the forms to user 160 in step 216, and the user selects the functions from the forms to incorporate to the application in step 218. Application 152 invokes WMI 156 to associate the incorporated function, defining the actions associated with the function in step 220, and the WMI incorporates the actions and sets up procedures to activate the BIOS functions via HII/WMI service 140 in step 222.

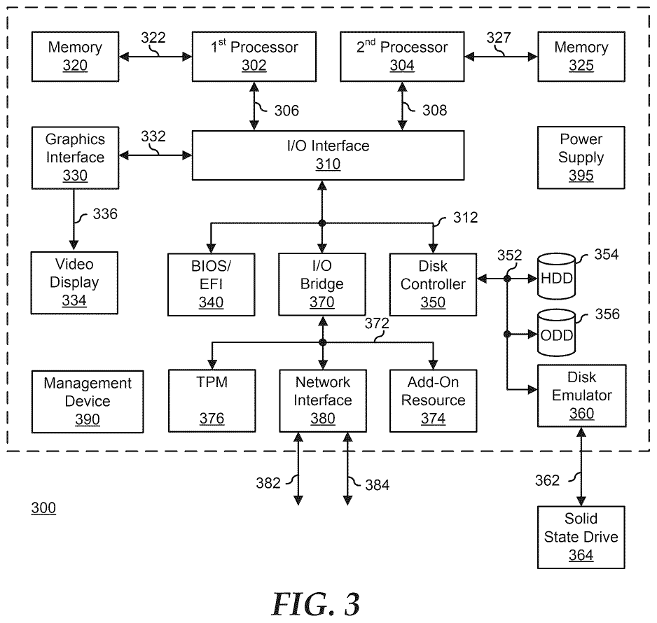

FIG. 3 illustrates a generalized embodiment of an information handling system 300 similar to information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 where peripheral interface 372 and the I/O channel are of the same type, and the I/O bridge translates information from a format suitable to the I/O channel to a format suitable to the peripheral channel 372 where they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 where the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed:

1. An information handling system, comprising:
a Unified Extensible Firmware Interface (UEFI) instantiated on a processor of the information handling system, the UEFI including a human interface infrastructure (HII);
an operating system (OS) instantiated on the processor, the OS including a Windows management instrumentation (WMI); and
an application instantiated on the OS, the application configured to invoke the WMI to query the HII, to receive information related to a function of the UEFI from the HII via the WMI, and to incorporate the function into the application.

2. The information handling system of claim 1, wherein the information related to the function is included in a HII database of the UEFI.

3. The information handling system of claim 2, wherein the information related to the function is provided to the HII database from a device associated with the function.

4. The information handling system of claim 2, wherein the information related to the function is provided to the HII data base from a UEFI driver.

5. The information handling system of claim1, wherein, in invoking the WMI to query the HII, the application is further configured to periodically invoke the WMI to query the HII.

6. The information handling system of claim 1, wherein the application is further configured to receive an indication from the WMI that the function is newly added to the UEFI.

7. The information handling system of claim 6, wherein invoking the WMI to query the HII is in response to receiving the indication.

8. The information handling system of claim 7, further comprising a baseboard management controller (BMC) configured to detect the presence of the function.

9. The information handling system of claim 8, wherein the BMC is configured to provide the indication to the WMI.

10. A method, comprising:
instantiating, on an information handling system, a Unified Extensible Firmware Interface (UEFI), wherein the UEFI includes a human interface infrastructure (HII);
instantiating, on the information handling system, an operating system (OS), wherein the OS includes a Windows management instrumentation (WMI);
instantiating, on the OS, an application;
invoking, by the application, the WMI to query the HII;
receiving, by the application, information related to a function of the UEFI from the HII via the WMI; and
incorporating the function into the application.

11. The method of claim 10, wherein the information related to the function is included in a HII database of the UEFI.

12. The method of claim 11, wherein the information related to the function is provided to the HII database from a device associated with the function.

13. The method of claim 11, wherein the information related to the function is provided to the HII data base from a UEFI driver.

14. The method of claim 10 wherein, in invoking the WMI to query the HII, the method further comprises periodically invoking the WMI to query the HII.

15. The method of claim 10 further comprising receiving, by the application, an indication from the WMI that the function is newly added to the UEFI.

16. The method of claim 15, wherein invoking the WMI to query the HII is in response to receiving the indication.

17. The method of claim 16, further comprising:
providing a baseboard management controller (BMC); and
detecting, by the BMC, the presence of the function.

18. The method of claim 17 further comprising providing, by the BMC, the indication to the WMI.

19. An information handling system, comprising:
a Unified Extensible Firmware Interface (UEFI) instantiated on a processor of the information handling system, the UEFI including a human interface infrastructure (HII);
an operating system (OS) instantiated on the processor, the OS including a Windows management instrumentation (WMI);
an application instantiated on the OS, the application configured to invoke the WMI to query the HII, to receive information related to a function of the UEFI from the HII via the WMI, and to incorporate the function into the application, wherein the information related to the function is included in a HII database of the UEFI; and
a baseboard management controller (BMC) configured to detect the presence of the function and to provide an indication to the WMI of the presence of the function.

20. The information handling system of claim 19, wherein the BMC is configured to provide the indication to the WMI.
